(19) United States
(12) Patent Application Publication
(10) Pub. No.: US 2016/0066519 A1
(43) Pub. Date: Mar. 10, 2016

(54) SAFETY EDGE AND IRRIGATION COMPONENT

(71) Applicant: Stratco (Australia) Pty Limited, Gepps Cross (AU)

(72) Inventor: James Matthew JANSEN, Gepps Cross (AU)

(21) Appl. No.: 14/783,265

(22) PCT Filed: Apr. 11, 2014
(86) PCT No.: PCT/AU2014/000393

§ 371 Date: Oct. 8, 2015

(30) Foreign Application Priority Data
Apr. 12, 2013 (AU) 2013204816

(51) Int. Cl. A01G 25/02; A01G 1/08

(52) U.S. Cl. CPC A01G 25/02; A01G 1/08

(57) ABSTRACT

The present invention relates to a combined safety edge and irrigation component including a pipe member for allowing a flow of fluid therethrough and an edge covering member for covering an exposed edge of a part to which the component is arranged to be attached. The invention also relates to a planter box kit including such a combined safety edge and irrigation component.

### CROSS REFERENCE

This application claims priority from Australian Complete Patent Application No. 2013204816 filed on 12 Apr. 2013, the contents of which are to be taken as incorporated herein by this reference.

### TECHNICAL FIELD

The present invention relates to a combined safety edge and irrigation component. The component has particular, but not exclusive, application as a safety edge on materials such as metal sheets which are used to build planter boxes and other simple structures where a supply of water may be required.

### BACKGROUND OF INVENTION

The walls of planter boxes or raised garden beds are commonly formed from metal sheets. In a very simple form, metal sheets, such as corrugated fencing type sheets, are located with their lower ends on the ground so as to form a perimeter wall for a raised garden bed. In a slightly more sophisticated arrangement, the metal sheets are attached to a simple “box” type frame and thus the attached sheets form the walls that retain the soil.

Planter boxes typically include a “box” type frame to which the wall sheets are attached. Such planter boxes adopt varying styles and sizes.

When metal sheets are used to form raised garden beds or planter boxes, the exposed edges of the metal sheets are often very sharp. To avoid any possible injury to someone contacting them, it is normal to cover the exposed edges. A very simple way of doing this is to secure a length of material over the exposed metal edge thereby preventing contact with the sharp edge. Alternatively, some sort of safety strip can be applied to the exposed edge of the metal sheet. Typically, the safety strip would be an extruded flexible plastics strip and the use of such a safety strip also improves the aesthetic appeal of the planter box.

Plants and vegetables growing in planter boxes and raised garden beds of the above described type need to be properly watered to ensure wellbeing. With the ever increasing focus on minimising water usage, it is preferable to water such arrangements using water delivered via an irrigation system, rather than from a hand held hose, a sprinkler or a watering can. Accordingly, some planter boxes are fitted with drip or spray irrigation systems that are arranged to be connected to an external water supply such as a garden tap or a rain water tank. This can lead to a cumbersome arrangement within the planter box because of the inclusion of the required protective cover over the sharp edge of the metal sheet and the inclusion of the irrigation system. The present invention seeks to address this cumbersome arrangement.

The discussion of the background to the invention herein is included to explain the context of the invention. This is not to be taken as an admission that any of the material referred to was published, known or part of the common general knowledge as at the priority date of this application.

### SUMMARY OF INVENTION

The present invention provides, in a first aspect, a combined safety edge and irrigation component including a pipe member for allowing a flow of fluid therethrough and an edge covering member for covering an exposed edge of a part to which the component is arranged to be attached.

The edge covering member preferably includes an opening arranged to receive the exposed edge of the part. The opening may be bounded, at least in part, by at least one resiliently deflectable tongue and a lower face. The tongue being arranged to displace to allow entry of the exposed edge into the opening and to then press against a portion of the part once the exposed edge is located within the opening so that the part is located between the tongue and the lower face so as to attach the component to the part.

In accordance with a preferred embodiment of the invention, the combined safety edge and irrigation component is arranged to be secured to a part such as an edge of a metal sheet. Accordingly, the opening, tongue and lower face are configured so that the component can be pushed onto the edge of the metal sheet so that the edge is received in the opening and thereafter the component is retained on the edge because of the engagement between the tongue, a part of the edge and lower face of the component. The tongue is configured to press onto the part of the edge so as to hold that part between the tongue and the lower face thereby retaining the component on the metal sheet. To the end, the tongue is preferably resiliently flexible.

The pipe member is preferably configured to establish a hollow of generally circular shaped cross-section for the flow of fluid through the component.

The pipe member is preferably arranged so that an outlet, such as a spray or dripper fitting, can be formed with or attached thereto to enable release of fluid from within the pipe member.

The pipe member and edge covering member are preferably integrally formed, for example as an extruded plastics component.

In accordance with a second aspect of the invention there is provided a planter box, said planter box including a perimeter wall having an upper edge, and at least one combined safety edge and irrigation component secured to a part of said upper edge, the combined safety edge and irrigation component including a pipe member for allowing a flow of fluid therethrough and an edge covering member for covering the upper edge of the perimeter wall.

Preferably, in use, the pipe member is arranged to be attached either directly or indirectly to an external water supply such as a garden tap or a rain water tank.

In accordance with a preferred embodiment of the invention, an irrigation path for the flow of fluid is established adjacent the perimeter wall of the planter box and extending substantially about the garden area bounded by the perimeter wall by way of the at least one combined safety edge and irrigation component. The irrigation path enabling fluid to pass through the pipe member and to be released via at least one outlet formed in the pipe member so that the garden area can be watered. The outlet may be established by one or more spray or dripper type fittings connected to the pipe member. A single or multiple combined safety edge and irrigation components may be used either alone or in conjunction with other irrigation system pieces to establish the irrigation path from a water supply to the garden area.

The invention further provides a kit of parts for constructing a planter box. The kit including a length of combined safety edge and irrigation component including a pipe member for allowing a flow of fluid therethrough and an edge covering member for covering an exposed edge of a part to which the component is arranged to be attached.

### BRIEF DESCRIPTION OF DRAWINGS

An embodiment of the invention will now be described, by way of example only, with reference to the accompanying drawings in which:

FIG. 1 is an end view of a combined safety edge and irrigation component in accordance with an embodiment of the invention;

FIG. 2 is an isometric view of the combined safety edge and irrigation component shown in FIG. 1;

FIG. 3 is a cross sectional elevation assembly showing a combined safety edge and irrigation component of FIG. 2 secured to an upper edge of a corrugated metal sheet;

FIG. 4 is an isometric assembly view of a combined safety edge and irrigation component according to an embodiment of the invention fitted to a corner of a planter box. The view is shown from “within” the box and looking “up” at the corner; and

FIG. 5 is an isometric view of a planter box fitted with a combined safety edge and irrigation component in accordance with an embodiment of the invention and arranged for connection to an external water supply.

### DETAILED DESCRIPTION

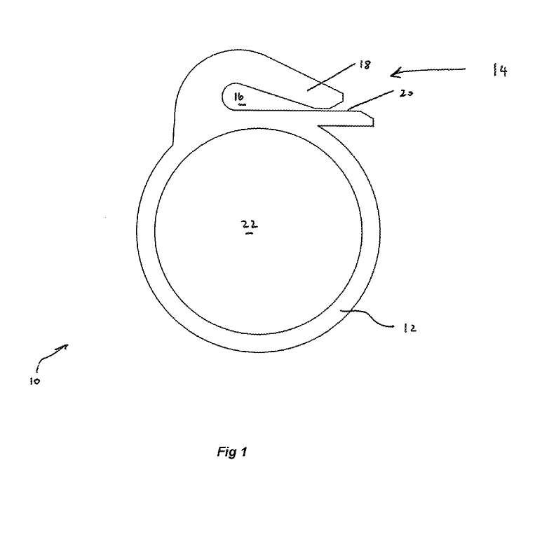

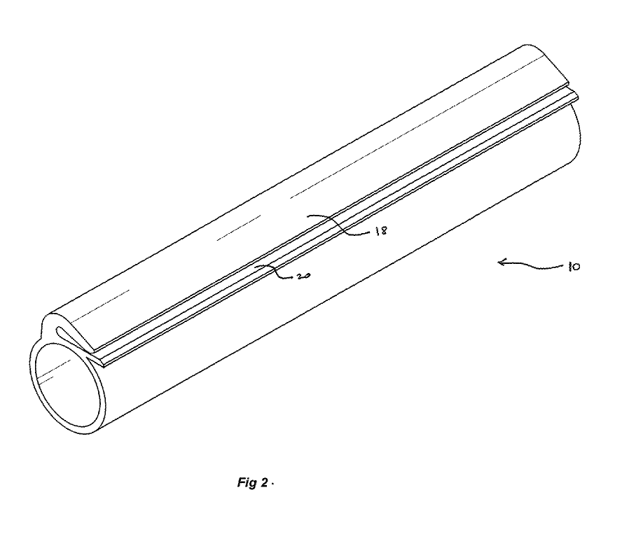

FIGS. 1 and 2 illustrate a combined safety edge and irrigation component 10 in accordance with an embodiment of the invention. The component 10 is made of a plastics material and is preferably formed as an extruded component. The component 10 may adopt different lengths and be made from different materials.

For the purpose of the following description, the component 10 is arranged to be attached to an upper edge 102 of a corrugated metal sheet 100. As described in one embodiment, the sheet 100 forms at least a part of a wall of a planter box. However, it should be understood that the component 10 could be attached to a variety of different parts and thus the present invention is not limited to use on metal sheets used in the construction of planter boxes. For example, a component in accordance with an embodiment of an invention could be attached to an upper edge of a length of fencing or an exposed edge of a roofing sheet.

The component 10 includes a pipe member 12 for allowing a flow of fluid therethrough and an edge covering member 14 for covering the upper edge 102 of the metal sheet 100 to which the component 10 is arranged to be attached. Although not depicted in the Figures, the component 10 may be arranged to be connected to other such components 10 and/or other irrigation system pieces so as to establish an irrigation path. For example, the irrigation path may be established to extend about the inner perimeter of a planter box and would be arranged to enable connection to an external water supply. In this way, water may be supplied to soil and/or plants within the planter box.

As best shown in FIG. 1, the edge covering member 14 includes an opening 16 arranged to receive the exposed upper edge 102 of the metal sheet 100. The opening 16 is bounded at least in part by a resiliently deflectable tongue 18 and a lower face 20. The tongue 18 is arranged to displace outwardly away from the lower face 20 to allow entry of the upper edge 102 of the metal sheet 100 into the opening 16. Once the upper edge 102 of the metal sheet 100 is located within the opening 16, the tongue 18 displaces downwardly so as to be located against a part or portion of the upper edge 102 of the metal sheet 100 thereby sandwiching that part of the metal sheet 100 between the tongue 18 and lower face 20. In this manner, the component 10 is securely attached to the upper edge 102 of the metal sheet 100.

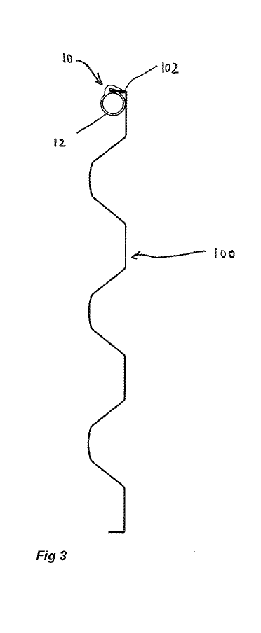

It will be appreciated that the component 10 is fabricated such that the edge covering member 14 can be pushed over the upper edge 102 of the metal sheet 100 so as to feed the upper edge 102 into the opening 16 and to then “hold” the upper edge 102 of the metal sheet 100 in a manner that will prevent the component 10 from being inadvertently detached. FIG. 3 illustrates the component 10 attached to the upper edge 102 of a corrugated metal sheet 100. It will be noted that the pipe member 12 is located on the inner side of the metal sheet 100. The inner side of the metal sheet 100 is the side that retains the soil when the metal sheet 100 is used to form a wall of a planter box.

The edge covering member 14 of the component 10 is integrally formed with the pipe member 12. The pipe member 12 defines a hollow 22 for allowing a flow of fluid therethrough.

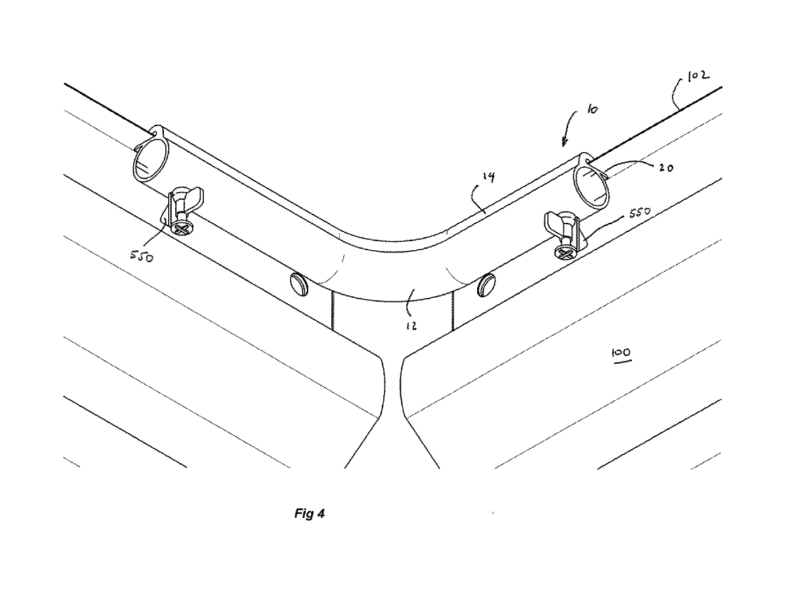

FIG. 4 illustrates the component 10 connected to a corner of a planter box 500. The planter box 500 has side walls made from corrugated metal sheet 100. For illustrative purposes, the component 10 is shown extending only part way about the upper inner perimeter of the planter box 500 and is not shown connected to any other irrigation system pieces. The component 10 is shown “bent” around the corner of the planter box 500.

It should be understood that the component 10, in use, would be arranged so as to be connected to a water supply and so that water could be supplied to the hollow 22 of the pipe member 12. In this manner, fluid contained within the pipe member 12 could be delivered via an outlet, such as a dripper or spray type fitting 550 to soil and/or plants within the planter box 500.

FIG. 4 illustrates the component 10 fitted with two spray fittings 550. The spray fittings 550 illustrated are connected to the pipe member 12 so that the barb used to connect the spray fitting 550 to the pipe member has an axis that extends substantially vertically. However, it will be appreciated that the fittings 550 can be connected to the pipe member 12 in any position that can be accessed and which establishes the spray or dripper pattern required by the user. Typically it is expected that the axis of the barb of the spray fitting 550 would be located at an angle anywhere within the arc of about 90-180° measured from the vertical. The required positioning of the fittings 550 will depend on, for example, the type and size of fittings 550 being used, the desired water delivery requirements, the profile of the metal sheet 100 and the height of the soil within the planter box 500.

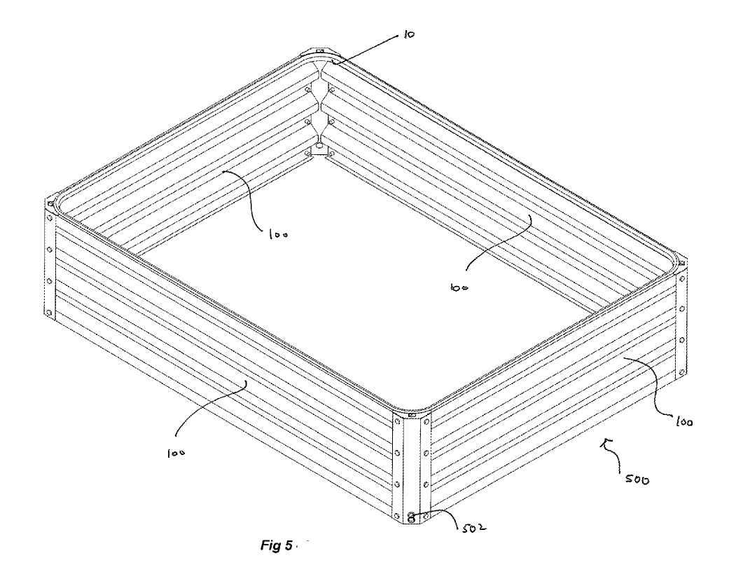

As best shown in FIG. 5, a length of component 10 extends around the inner perimeter of the planter box 500. At the front corner of the planter box 500 the ends of the component 10 are joined to a standard three prong T piece or corner elbow with three openings (not visible). The third pipe opening of the T piece or corner elbow is connected to a length of vertical pipe (not visible) that is located inside the planter box 500 and which is directed downwardly along the height of the planter box 500. That lower end of the length of vertical pipe is then connected to an outlet 502.

The outlet 502 may adopt different forms but is preferably an outlet of the type that would allow a hose fitting to be easily connected thereto. A flow of water can then be provided up the vertical pipe, through the three prong T piece or corner elbow and into the hollow 22 of the pipe member 12 of the component 10. In this manner, a fluid flow path is established through the component 10 and around the inner perimeter of the planter box 500. Outlet fittings 550 can then be located in the pipe member 12 of the component 10 to disburse water to the soil and/or plants within the planter box.

Embodiments of the present invention are advantageous because they provide a combined safety edge and irrigation component that can be readily attached to an exposed edge such as that of a metal sheet. The component prevents contact with any part of the exposed edge received within the opening of the component and therefor protects against accidental injury. Furthermore, the component provides an arrangement whereby an irrigation path can be established along the length of the metal sheet (or other article) to which it is attached. This enables a supply of water to be delivered via outlets formed or attached in the component to an area adjacent to the component. Typically, the outlets would be established by fitting standard spray or dripper irrigation fittings to the component in the same manner they are applied to industry standard irrigation pipe. Such fittings would normally be applied to the component after the component has been attached to the metal sheet. However, it is envisaged that other applications may be adopted.

The component is easy to attach and eliminates the need to have one mechanism for covering the exposed edge of the metal sheet (or other article) and another mechanism to provide irrigation to a required area.

The component is relatively inexpensive to manufacture and is easy to supply and install.

The embodiments have been described by way of example only and modifications within the spirit and scope of the invention are envisaged.

1. A combined safety edge and irrigation component including: an edge covering member;
a pipe member for allowing a flow of fluid therethrough, said pipe member connected to the edge covering member;
said edge covering member arranged for attachment to and covering of an exposed edge of a part to which the component is arranged to be attached, said edge covering member including:
an opening arranged to receive the exposed edge of the part, said opening bounded, at least in part, by at least one resiliently deflectable tongue and a lower face; and
wherein the tongue is arranged to initially displace to allow entry of the exposed edge of the part into the opening and to then press back against a portion of the part once the exposed edge is located within the opening so that the exposed edge of the part is held between the tongue and the lower face so as to attach the component to the part and to cover the exposed edge thereby preventing inadvertent contact with the exposed edge which may cause injury.

2. (canceled)

3. (canceled)

4. (canceled)

5. (canceled)

6. A combined safety edge and irrigation component according to claim 1 wherein the pipe member is configured to provide a generally circular cross-sectional shaped hollow for the flow of fluid through the component.

7. A combined safety edge and irrigation component according to claim 1 including at least one outlet to allow fluid from within the pipe member to flow out thereof.

8. A combined safety edge and irrigation component according to claim 7 wherein the at least one outlet includes a spray or dripper fitting attached to the pipe member to enable flow of fluid from within the pipe member.

9. A combined safety edge and irrigation component according to claim 1 wherein the pipe member and edge covering member are integrally formed.

10. A planter box, said planter box including a perimeter wall having an upper exposed edge, and at least one combined safety edge and irrigation component secured to a part of said upper exposed edge, the combined safety edge and irrigation component including:
an edge covering member;
a pipe member for allowing a flow of fluid therethrough, said pipe member connected to the edge covering member;
said edge covering member arranged for attachment to and covering of the exposed edge, said edge covering member including:
an opening arranged to receive the exposed edge of the planter box, said opening bounded, at least in part, by at least one resiliently deflectable tongue and a lower face; and
wherein the tongue is arranged to initially displace to allow entry of the exposed edge of the planter box into the opening and to then press back against a portion of the planter box once the exposed edge is located within the opening so that the exposed edge of the planter box is held between the tongue and the lower face so as to attach the component to the planter box and to cover the exposed edge thereby preventing inadvertent contact with the exposed edge which may cause injury.

11. A planter box according to claim 10 wherein the pipe member is arranged to be attached either directly or indirectly to an external water supply such as a garden tap or a rain water tank.

12. A planter box according to claim 10 wherein said at least one combined safety edge and irrigation component establishes an irrigation path for the flow of fluid adjacent the perimeter wall of the planter box and extending substantially about a garden area bounded by the perimeter wall.

13. A planter box according to claim 12 wherein the irrigation path enables fluid to pass through the pipe member and to be released via at least one outlet formed in the pipe member so that the garden area can be watered.

14. A planter box according to claim 13 where the outlet is established by one or more spray or dripper type fittings connected to the pipe member.

15. A kit of parts for constructing a planter box, said kit including a combined safety edge and irrigation component according to claim 1 and a plurality of metal sheets for forming a perimeter wall of the planter box.

16. A combined safety edge and irrigation component according to claim 1 wherein the exposed edge of the part is an edge of a metal sheet.

17. A planter box according to claim 10 wherein the perimeter wall includes at least one metal sheet.
